(19) United States
(12) Patent Application Publication
(10) Pub. No.: US 2026/0211634 A1
(43) Pub. Date: Jul. 23, 2026

(54) Artificial Intelligence-Based Code Generation and Testing

(71) Applicant: Bank of America Corporation, Charlotte, NC (US)

(72) Inventors: Thresiamma Louis, Concord, NC (US); Miguel Hernandez Mendoza, Charlotte, NC (US)

(21) Appl. No.: 19/028,227

(22) Filed: Jan. 17, 2025

(51) Int. Cl. G06F 8/35; G06N 20/00

(52) U.S. Cl. CPC G06F 8/35; G06N 20/00

(57) ABSTRACT

Arrangements for using artificial intelligence to generate and test code are provided. A computing platform may train a generative artificial intelligence (AI) model to output code segments and test the code segments for compliance with compliance criteria. The model may be trained using general knowledge data, enterprise specific data, and industry and/or government regulations. The computing platform may receive a request for a code segment that may include technical specifications of the code segment. The model may be executed, using the technical specifications as inputs, to output the code segment. The code segment may then be tested, using the model, to ensure compliance with the compliance criteria. If the code segment complies, the code segment may be deployed. If not, the computing platform may tune the model and the tuned model may be executed to output an updated code segment, which may then be tested for compliance.

### BACKGROUND

Aspects of the disclosure relate to electrical computers, systems, and devices for using artificial intelligence to generate and test computer code.

Code generation is an essential aspect of every enterprise organization. In conventional arrangements, developers may write code that may be tested, evidence captured, and the like. This process may include various aspects performed by one or more developers and can be time consuming and prone to errors. Conventional automated systems for code generation may improve efficiency but do not include enterprise specific data or artifacts when generating code. Accordingly, it would be advantageous to use artificial intelligence to generate enterprise specific code and test code for compliance with one or more compliance criteria.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical issues associated with accurately generating and testing enterprise specific computer code.

In some examples, a computing platform may train a generative artificial intelligence (AI) model to output or produce code segments and test the code segments for compliance with one or more compliance criteria. The generative AI model may be trained using general knowledge data, as well as enterprise specific data and regulations, and industry and/or government regulations.

The computing platform may receive a request for a code segment that may include technical specifications of the code segment. The generative AI model may be executed, using the technical specifications as inputs, to output the code segment. The code segment may then be tested, using the generative AI model, to ensure compliance with one or more compliance criteria. If the code segment complies, the code segment may be deployed. If not, the computing platform may tune the generative AI model and the tuned model may be executed to output an updated code segment, which may then be tested for compliance.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for generating and testing computer code using artificial intelligence in accordance with one or more aspects described herein;

FIGS. 2A-2D depict an illustrative event sequence for generating and testing computer code using artificial intelligence in accordance with one or more aspects described herein;

FIG. 3 illustrates an illustrative method for generating and testing computer code using artificial intelligence according to one or more aspects described herein;

FIGS. 4 and 5 depict illustrative user interfaces that may be generated in accordance with one or more aspects described herein; and

FIG. 6 illustrates one example environment in which various aspects of the disclosure may be implemented in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed above, generating computer code may be a time consuming process that may be prone to errors. For instance, in many arrangements, validation of code is a substantially manual process that can slow deployment of code. Accordingly, arrangements described herein use generative artificial intelligence (AI) to generate computer code, test the code for compliance, capture evidence based on the testing, and the like.

As discussed herein, the arrangements described may be used in various cloud environments. The arrangements enable use of generative AI to generate a code segment based on technical specifications provided by an enterprise organization. The generative AI model may be trained using enterprise specific artifacts, as well as industry or government regulations. Accordingly, the generated code segment may be tested, using the generative AI model, to confirm compliance with various business requirements of the enterprise organization, regulatory requirements, and the like.

As also discussed herein, the systems described may integrate with one or more downstream systems and/or applications to enable efficient capture of evidence from the development and testing of the code. This may ensure accurate and efficient validation of generated code.

These and various other arrangements will be discussed more fully below.

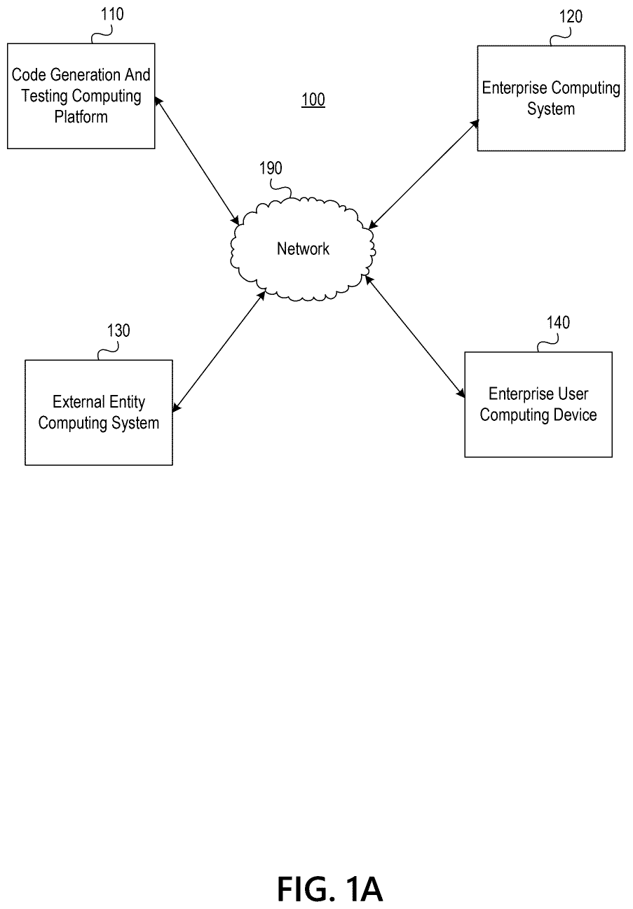

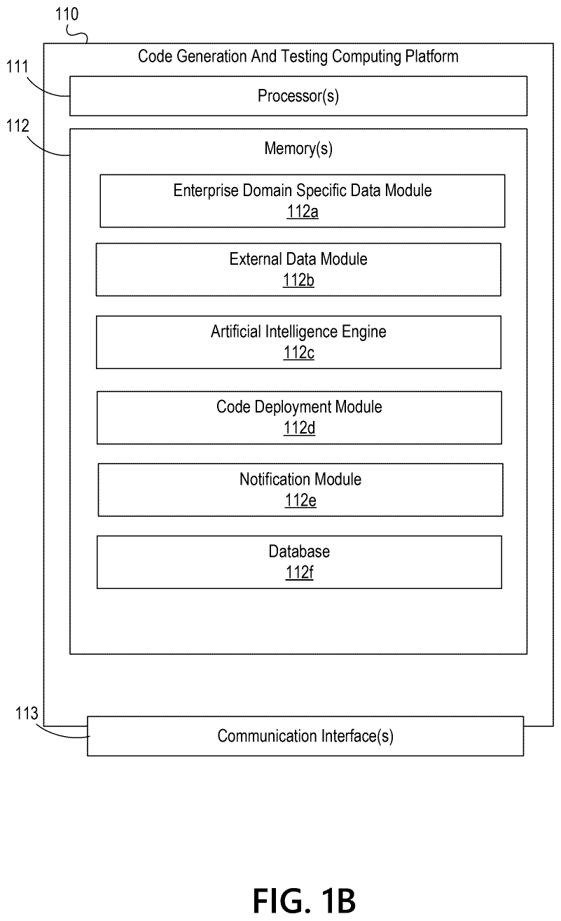

FIGS. 1A-1B depict an illustrative computing environment and devices for generative artificial intelligence code generation and testing in accordance with one or more aspects described herein. Referring to FIG. 1A, computing environment 100 may include one or more computing devices and/or other computing systems. For example, computing environment 100 may include code generation and testing computing platform 110, enterprise computing system 120, external entity computing system 130 and enterprise user computing device 140.

Although one enterprise computing system 120, external entity computing system 130 and enterprise user computing device 140 are shown, any number of systems or devices may be used without departing from the invention.

Code generation and testing computing platform 110 may be or include one or more computer components (e.g., servers, server blade, processor, memory, and the like) and may be configured to perform intelligent, dynamic, generation and testing of infrastructure as code using generative artificial intelligence (AI). For instance, the code generation and testing computing platform 110 may train a generative AI model using, for instance, one or more large language models (LLMs) including general knowledge (e.g., customer data, publicly available data, and the like). In addition, the AI model may be trained using enterprise domain specific data (e.g., code requirements associated with the enterprise) and regulatory data (e.g., regulatory requirements associated with an industry of the enterprise organization.

Based on the trained model, technical specifications associated with a request to generate one or more segments of code (e.g., infrastructure as code) may be input to the model. The model may be executed to output the one or more segments of code. Further, the model may then be executed on the generated one or more segments of code to determine whether it meets one or more compliance criteria (e.g., regulatory requirements, business requirements of the enterprise organization, or the like). If so, the code may be deployed. If not, the code generation and testing computing platform 110 may generate and transmit a notification to a computing device, such as enterprise user computing device 140, including a recommendation to tune or re-train the AI model. After turning the model, the model may be executed again using the technical specifications and a determination may be made as to whether the output code segment complies with the one or more compliance criteria.

Enterprise computing system 120 may be or include one or more computer components (e.g., servers, server blade, processor, memory, and the like) and may be configured to host or store one or more applications or data including customer data, business regulation data, and the like. In some examples, the data from enterprise computing system 120 may be used to train the generative AI model.

External entity computing system 130 may be or include one or more computer components (e.g., servers, server blade, processor, memory, and the like) and may be configured to host or store one or more applications or data including publicly available data and/or regulatory data (e.g., data related to regulatory requirements of the industry of the enterprise organization). The data from external entity computing system 130 may be used to train the generative AI model.

Enterprise user computing device 140 may be or include one or more computing devices (e.g., laptop computers, desktop computers, mobile devices, tablet devices, or the like) that may be used by an employee, agent, associate or other user of the enterprise organization implementing the code generation and testing computing platform 110. In some examples, enterprise user computing device 140 may receive and/or display notifications indicating an output of the generative AI model, a recommendation for tuning or retraining the model, a dashboard indicating an accuracy of the model, or the like. In some examples, enterprise user computing device 140 may be used to facilitate tuning or retraining the generative AI model.

As mentioned above, computing environment 100 also may include one or more networks, which may interconnect one or more of code generation and testing computing platform 110, enterprise computing system 120, external entity computing system, 130 and/or enterprise user computing device 140. For example, computing environment 100 may include network 190. Network 190 may, in some examples, be a private network and include one or more sub-networks (e.g., Local Area Networks (LANs), Wide Area Networks (WANs), or the like). In some examples, network 190 may be a public network or may include a public network and private network in communication with each other. Network 190 may interconnect one or more computing devices associated with the organization and/or external to the organization. For example, code generation and testing computing platform 110, enterprise computing system 120, external entity computing system, 130 and/or enterprise user computing device 140 may be connected via network 190.

Referring to FIG. 1B, code generation and testing computing platform 110 may include one or more processors 111, memory 112, and communication interface 113. A data bus may interconnect processor(s) 111, memory 112, and communication interface 113. Communication interface 113 may be a network interface configured to support communication between code generation and testing computing platform 110 and one or more networks (e.g., network 190, or the like). Memory 112 may include one or more program modules having instructions that when executed by processor(s) 111 cause code generation and testing computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of code generation and testing computing platform 110 and/or by different computing devices that may form and/or otherwise make up code generation and testing computing platform 110.

For example, memory 112 may have, store and/or include enterprise domain specific data module 112a. Enterprise domain specific data module 112a may store instructions and/or data that may cause or enable the code generation and testing computing platform 110 to retrieve, from one or more enterprise systems, such as enterprise computing system 120, enterprise data associated with customers, business regulations, and the like. In some examples, the data may be used to train a generative AI model. In some examples, a large language model already in use by the enterprise organization and trained based on, for instance, customer or enterprise data, may be used as a starting point for the generative AI model. The generative AI model may then further use business regulations and the like for training. In some examples, enterprise domain specific data module 112a may further store instructions and/or data that may retrieve technical specifications associated with a segment of code for which a request for generation has been received. For instance, code generation and testing computing platform 110 may receive a request to generate a segment of code and may retrieve, from enterprise domain specific data module 112a, technical specifications associated with the requested code.

Code generation and testing computing platform 110 may further have, store and/or include external data module 112b. External data module 112b may store instructions and/or data that may cause or enable the code generation and testing computing platform 110 to retrieve, from one or more external systems, such as external entity computing system 130, data external to the enterprise organization that may be used to train the generative AI model. For instance, government regulations or other requirements associated with the industry of the enterprise organization, as well as other related publicly available data may be received from one or more external entity computing systems 130 and retrieved from external data module 112b to train the generative AI model.

Code generation and testing computing platform 110 may further have, store and/or include artificial intelligence engine 112c. Artificial intelligence engine 112c may store instructions and/or data that may cause or enable the code generation and testing computing platform 110 to train a generative AI model using internal and external data. In some examples, an existing large language model or other neural network trained using enterprise customer data and/or other data may provide a basis for the generative AI model. The generative AI model may then be further trained or tuned based on enterprise domain specific data (e.g., business regulations, and the like) as well as external or publicly available data (e.g., industry requirements or regulations). The artificial intelligence engine 112c may further store instructions and/or data that may cause or enable the code generation and testing computing platform 110 to execute the generative AI model using technical specifications for a requested segment of code (e.g., infrastructure as code) as inputs to output the requested infrastructure as code segment. In some examples, the artificial intelligence engine 112c may further execute the generative AI model on the generated code to determine compliance with one or more compliance criterial (e.g., enterprise criteria, regulatory criteria, and the like). Based on the outcome of the analysis, the generative AI model may be further tuned or retrained, or the code segment may be deployed.

Code generation and testing computing platform 110 may further have, store and/or include code deployment module 112d. Code deployment module 112d may store instructions and/or data that may cause or enable the code generation and testing computing platform 110 to compile one or more code segments that comply with the one or more compliance criteria and sent the compiled code to a deployment environment.

Code generation and testing computing platform 110 may further have, store and/or include notification module 112e. Notification module 112e may store instructions and/or data that may cause or enable the code generation and testing computing platform 110 to generate one or more notifications indicating that generated segments of code do not comply with one or more compliance criteria, recommending tuning or retraining of the generative AI model, providing accuracy data of the generative AI model to understand when accuracy is below a threshold, or the like.

Code generation and testing computing platform 110 may further have, store and/or include database 112f. Database 112f may store data related to internal customer data, business rules or regulations, external regulation data, model accuracy data, compliance data, and/or any other data to perform the functions of code generation and testing computing platform 110.

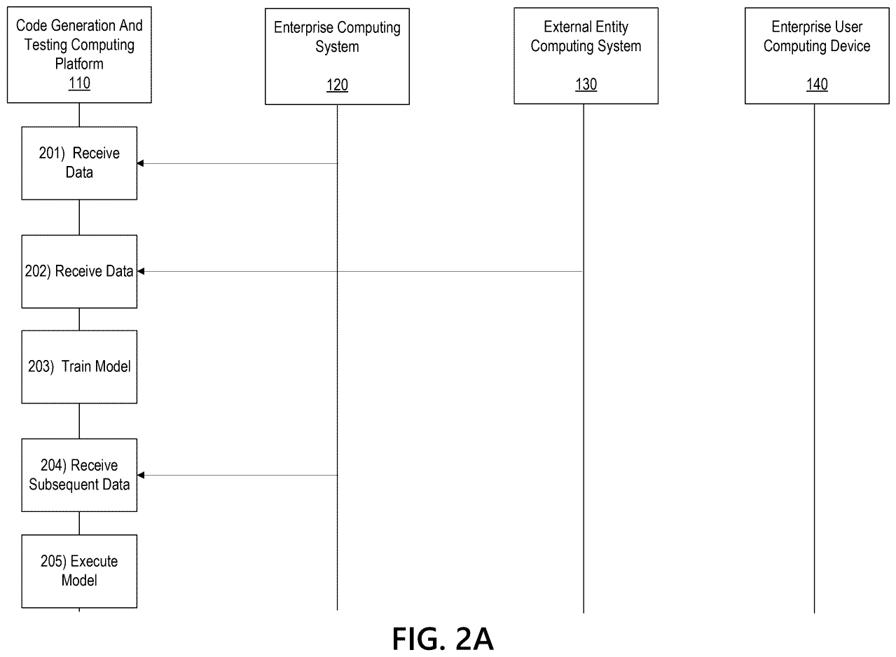

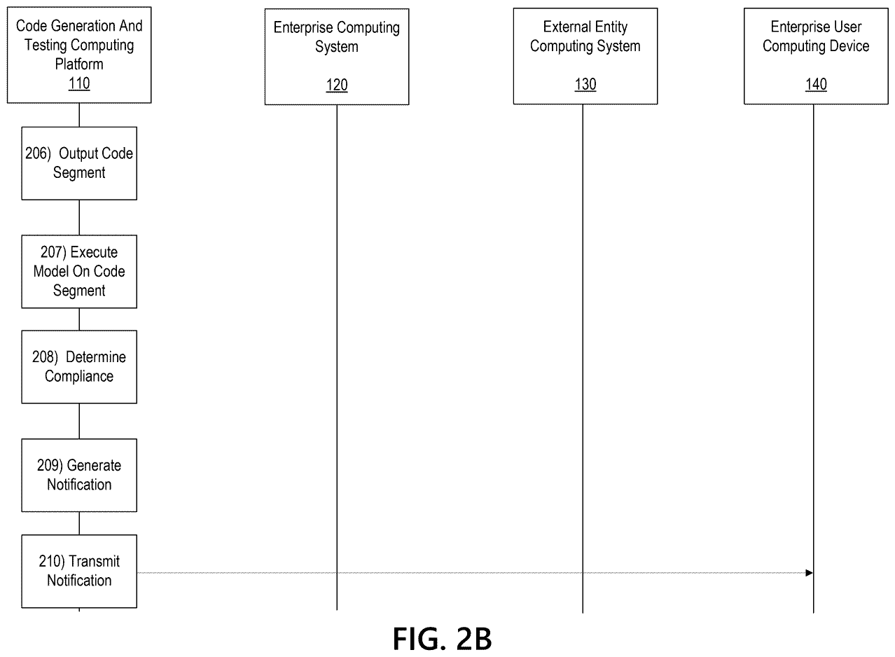

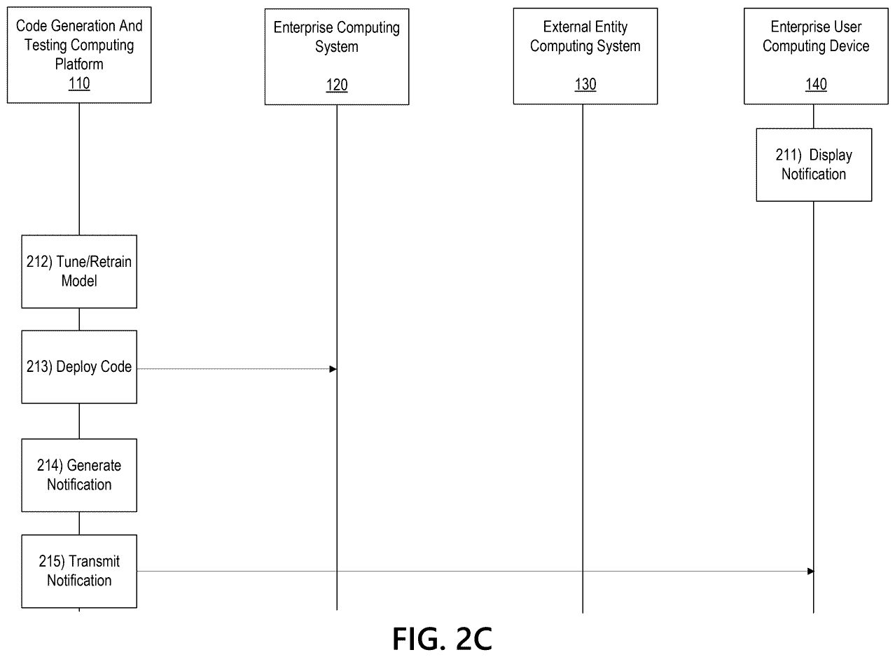

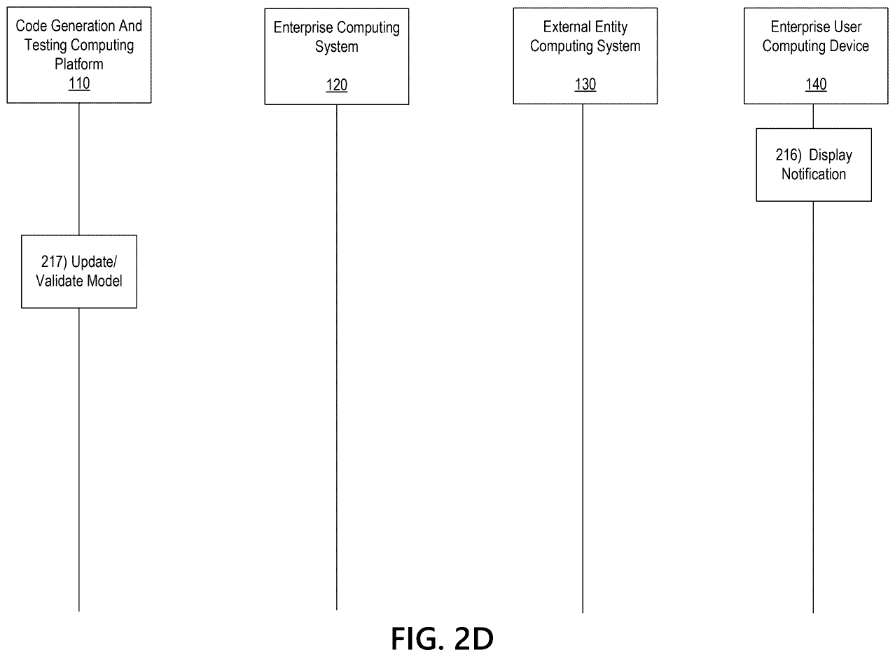

FIGS. 2A-2D depict one example illustrative event sequence for generative AI based code generation and testing in accordance with one or more aspects described herein. The events shown in the illustrative event sequence are merely one example sequence and additional events may be added, or events may be omitted, without departing from the invention. Further, one or more processes discussed with respect to FIGS. 2A-2D may be performed in real-time or near real-time.

With reference to FIG. 2A, at step 201, code generation and testing computing platform 110 may receive data from one or more enterprise systems, such as enterprise computing system 120. In some examples, the data may include customer data, code segments (e.g., infrastructure as code segments), business regulation or rule data, or the like. In some examples, the data received may include a large language model that may provide a basis for a generative AI model used to generate and test code.

At step 202, code generation and testing computing platform 110 may receive data from one or more external systems, such as external entity computing system 130. In some examples, the data may include industry or government regulatory data associated with an industry of the enterprise organization, publicly available data, and the like.

At step 203, code generation and testing computing platform 110 may train a generative AI model. For instance, based on the data received from enterprise computing system 120 and/or external entity computing system 130, code generation and testing computing platform 110 may train a generative AI model to output or produce code segments based on technical specifications (e.g., infrastructure as code segments) and to test the generated code segments. Training the generative AI model may cause the model to identify patterns, sequences or correlations in data in order to output or generate code segments (e.g., infrastructure as code segments) and test the code segments for compliance. For instance, code generation and testing computing platform 110 may feed the data received at steps 201 and 202 into the generative AI model to establish stored correlations between technical specifications, code and compliance criteria. In some examples, one or more neural networks underlying the generative AI model may implement self-learning processes to generate code segments (e.g., infrastructure as code segments) based on training data (e.g., training data that may, in some examples, include previously generated code segments) and execute compliance verification processes to test the generated code to ensure compliance with one or more compliance criteria (e.g., business compliance criteria, government or industry compliance criteria, or the like). Additionally or alternatively, code generation and testing computing platform 110 may use one or more supervised learning techniques (e.g., decision trees, bagging, boosting, random forest, k-NN, linear regression, artificial neural networks, support vector machines, and/or other supervised learning techniques), unsupervised learning techniques (e.g., classification, regression, clustering, anomaly detection, artificial neutral networks, and/or other unsupervised models/techniques), and/or other techniques.

At step 204, code generation and testing computing platform 110 may receive subsequent data from enterprise computing system 120. For instance, code generation and testing computing platform 110 may receive a request to generate one or more code segments (e.g., infrastructure as code segments), as well as technical specifications (e.g., design requirements, and the like) associated with the requested code segment(s).

At step 205, code generation and testing computing platform 110 may input the technical specifications to the generative AI model and may execute the model to output the requested code segment(s). In some examples, the generative AI model may generate code that is language agnostic.

With reference to FIG. 2B, at step 206, the code generation and testing computing platform 110 may output the code generated based on execution of the generative AI model.

At step 207, code generation and testing computing platform 110 may input the generated code to the generative AI model and may execute the model to determine whether the model complies with one or more compliance criteria. For instance, the model may compare the generated code and aspects or features of the code to one or more compliance criteria (e.g., business rules or regulations, industry or government rules or regulations, and the like) to determine whether the one or more compliance criteria are met.

At step 208, the code generation and testing computing platform 110 may determine, based on the output of the model, whether the one or more compliance criteria are met. If so, the process may proceed to step 213 in FIG. 2C to deploy the generated code segment(s).

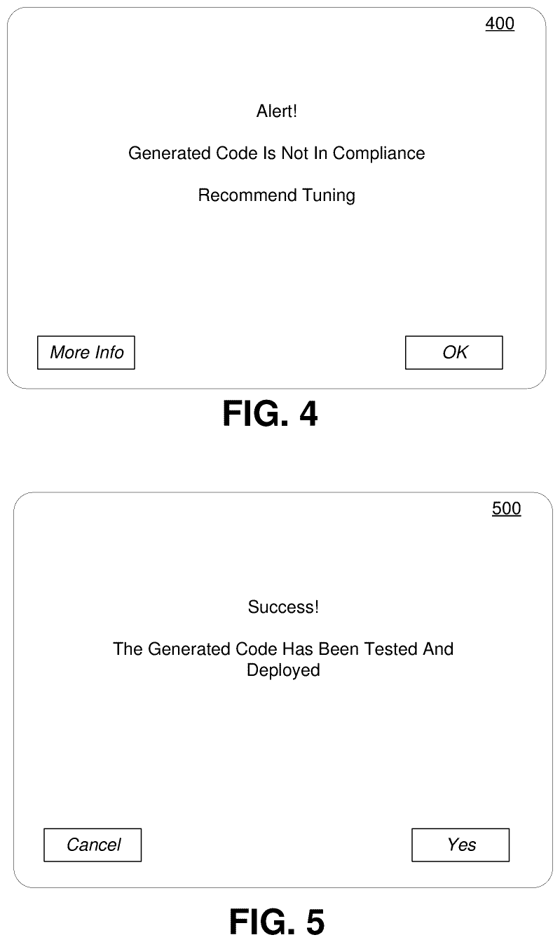

If, at step 208, the code generation and testing computing platform 110 determines that the generated code does not comply with the one or more compliance criteria, at step 209, code generation and testing computing platform 110 may generate a notification indicating that the generated code does not comply. In some examples, the notification may include a recommendation to tune or retrain the model. In some arrangements, tuning or retraining the model may be performed based on user input in response to the notification or automatically upon failure of the compliance check. FIG. 4 illustrates one example notification 400 indicating that the generated code is not in compliance with the one or more compliance criteria. In addition, the notification 400 may include a recommendation to tune or retrain the model. In some examples, selection of “more info” option may prompt the user to provide user input authorizing tuning of the model.

At step 210, code generation and testing computing platform 110 may transmit or send the generated notification to enterprise user computing device 140. In some examples, transmitting or sending the notification may cause the notification to be displayed by a display of the enterprise user computing device 140.

With reference to FIG. 2C, at step 211, enterprise user computing device 140 may receive and display the notification.

At step 212, either in response to user input received from the enterprise user computing device 140 in response to the notification, or automatically, code generation and testing computing platform 110 may tune or retrain the model. For instance, one or more parameters may be adjusted, additional training data may be obtained, or the like, to improve the accuracy of the model.

After tuning or retraining the model, the process may return to step 205 to execute the tuned model on the technical specifications, output code based on the tuned model, execute the model to test the code for compliance, and either retune or deploy the code based on the outcome.

Once it is determined that the generated code meets the one or more compliance criteria, the code may be deployed at step 213. In some examples, deploying the code may include compiling the code, transmitting or sending the compiled code to a production environment, such as enterprise computing system 120, or the like. In some examples, deploying the code may further include integrating the output with one or more downstream systems or applications of the enterprise organization. For instance, one or more work management tools, source version control tools, or the like, may integrate with the code generation and testing computing platform 110 (e.g., via an application programming interface) to receive outputs and other data that may be used in the downstream systems.

At step 214, code generation and testing computing platform 110 may generate a notification indicating that the code has been tested and deployed. FIG. 5 illustrates one example notification 500 that may be generated. The notification 500 includes an indication that the generated code has been tested and deployed, indicating that the code was in compliance with the one or more compliance criteria.

At step 215, the generated notification may be transmitted or sent to the enterprise user computing device 140. In some examples, transmitting or sending the notification may cause the notification to be displayed by a display of the enterprise user computing device 140.

With reference to FIG. 2D, at step 216, enterprise user computing device 140 may receive and display the notification.

At step 217, code generation and testing computing platform 110 may update and/or validate the generative AI model. For instance, the generated code, compliance results, and the like, may be provided to the generative AI model via a feedback loop. Accordingly, the generative AI model may be refined to continuously improve accuracy.

In some examples, code generation and testing computing platform 110 may continuously update, validate, refine, or the like, the generative AI model. In some arrangements, the code generation and testing computing platform 110 may maintain an accuracy threshold for the generative AI model and may pause refinement (through the dynamic feedback loop) of the model if the corresponding accuracy is identified as greater than the accuracy threshold. Further, if the accuracy is at or below the accuracy threshold, the code generation and testing computing platform 110 may resume refinement of the model through the corresponding dynamic feedback loop. In some examples, accuracy and threshold information may be provided to, for instance, enterprise user computing device 140 via user interface or dashboard providing options for control, training, execution, and the like, of the generative AI model.

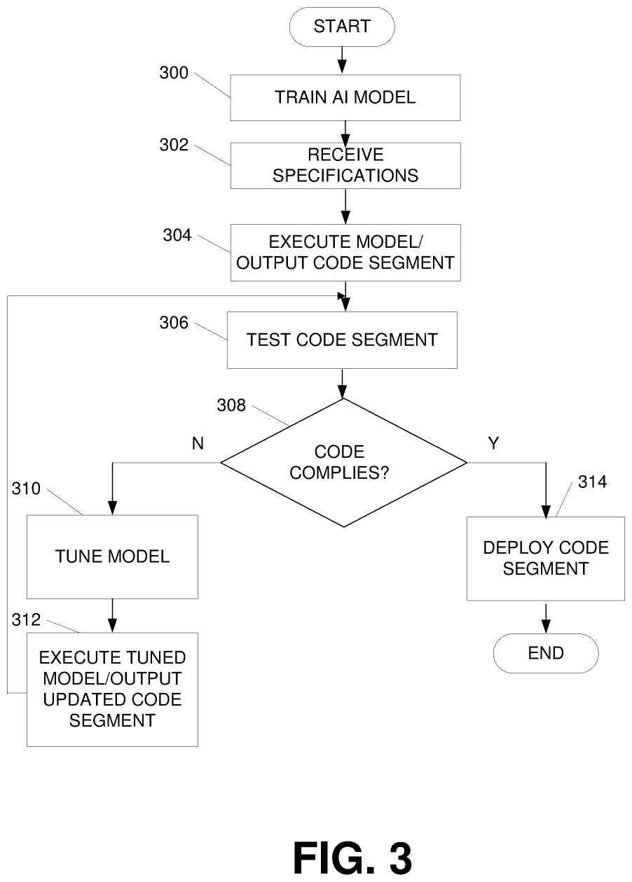

FIG. 3 is a flow chart illustrating one example method of using generative artificial intelligence to generate and test code segments in accordance with one or more aspects described herein. The processes illustrated in FIG. 3 are merely some example processes and functions. The steps shown may be performed in the order shown, in a different order, more steps may be added, or one or more steps may be omitted, without departing from the invention. In some examples, one or more steps may be performed simultaneously with other steps shown and described. One of more steps shown in FIG. 3 may be performed in real-time or near real-time.

At step 300, code generation and testing computing platform 110 may train a generative AI model. For instance, code generation and testing computing platform 110 may receive internal and external data and may train the generative AI model to output or produce code segments, such as infrastructure as code segments, and test the code segments for compliance.

At step 302, code generation and testing computing platform may receive a request to generate a code segment and technical specifications for the code segment. In some examples, the request for the code segment and technical specifications may be received from an internal computing system, such as enterprise computing system 120.

At step 304, code generation and testing computing platform may execute the trained generative AI model using the technical specifications as inputs to output the requested code segment.

At step 306, code generation and testing computing platform 110 may test the generated code segment for compliance with one or more compliance criteria. In some examples, testing the code segment may include executing the generative AI model to evaluate the code segment for compliance with the one or more compliance criteria. In some examples, the one or more compliance criteria may include enterprise domain specific criteria, such as business rules or regulations. Additionally or alternatively, the one or more compliance criteria may include regulatory data (e.g., government or industry regulatory data).

At step 308, code generation and testing computing platform 110 may determine whether the generated code segment complies with the one or more compliance criteria. If so, at step 314, the code segment may be deployed. In some examples, deploying the code segment may include integrating the code generation and testing computing platform 110 with one or more downstream systems or applications to provide data (e.g., outputs or the like) to the one or more downstream systems or applications. In some examples, the deploying the code segment may include generating a notification indicating compliance with the one or more compliance criteria and indicating that the code segment has been deployed, and transmitting or sending the notification to enterprise user computing device 140. Transmitting the notification may cause the notification to be displayed on a display of enterprise user computing device 140.

If, at step 308, the generated code segment does not comply with the one or more compliance criteria, at step 310, the generative AI model may be tuned or retrained. In some examples, a notification indicating non-compliance may be transmitted to enterprise user computing device 140, which may cause the notification to be displayed on a display of enterprise user computing device 140. In some examples, the model may be tuned or retrained in response to user input received via the notification. In other arrangements, the model may be tuned or retrained automatically in response to non-compliance.

At step 312, the tuned or retrained model may be executed using the technical specifications as inputs in order to output an updated code segment. The process may then return to step 306 to test the updated code segment.

As discussed herein, aspects described are directed to generation of code segments and testing of code segments using artificial intelligence. In some examples, the arrangements described may be used in a cloud environment and may be cloud agnostic or usable with various different types of cloud environments.

The arrangements provided rely on generative AI models to output or produce code segments, such as infrastructure as code segments, and test the generated code segments for compliance with internal business rules and regulations, as well as external regulatory requirements. In some examples, the generative AI model may be trained using general knowledge data, as well as enterprise specific data and industry specific regulatory data. The training data may include enterprise domain specific controls and/or templates and the output of the model may feed into one or more downstream systems or applications of the enterprise organization.

In some examples, by feeding outputs or other data into the one or more downstream systems or applications, the arrangements described enable collection of evidence that may be necessary for quality assurance, compliance, and the like. For instance, the testing outputs may be provided to one or more downstream systems or applications and may be stored for use in quality logs, audit data, and the like. In some examples, the systems described herein may integrate with one or more third-party systems to provide accurate data to those systems. This may reduce the likelihood of error in the reporting.

In some examples, because of the nature of cloud-based applications that share knowledge, the arrangements described herein may leverage generally available sets of data (e.g., training data) that may be enriched by a community of practitioners. In some examples, an existing LLM may be used as a foundation of the generative AI model and may be further trained using the enterprise specific standards discussed herein.

As discussed, in some arrangements, the code generated may be infrastructure as code. For instance, the code may provide ways to source control infrastructure (e.g., what configuration should look like, management, and the like). This may aid in replicating environments and may reduce or eliminate waste. However, in some examples, infrastructure as code may be prone to errors. Accordingly, the arrangements described provide the benefits of infrastructure as code (e.g., efficiency, and the like) while minimizing potential for error by ingesting existing artifacts from enterprise systems (e.g., business rules, regulatory requirements, technical specifications, and the like).

Although the arrangements described are generally directed to generating code segments and testing the code segments using the generative AI model, in some examples, the generative AI model may be used to generate code segments or test code segments generated through other means.

The arrangements described further ensure that security and privacy requirements are maintained. For instance, business rules may include security and/or privacy requirements and, accordingly, proper encryption may be used when executing the model, deploying code, and the like.

As discussed above, the arrangements described may be language agnostic, such that code generated may be used with various systems. Further, the systems described herein provide user-friendly interfaces (e.g., notifications, dashboard, or the like) for training the generative AI model, for understanding current accuracy of the generative AI model, for retraining or tuning the generative AI model, and the like.

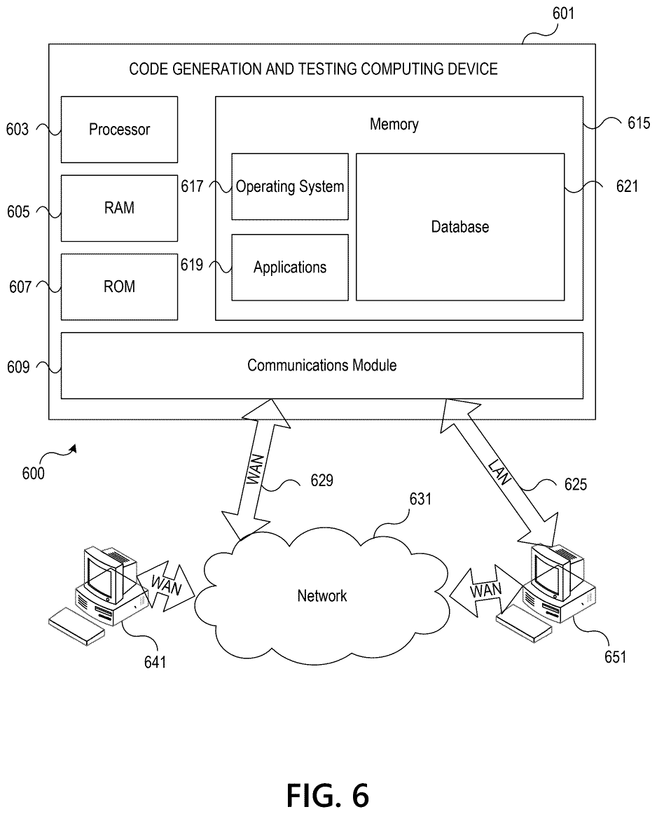

FIG. 6 depicts an illustrative operating environment in which various aspects of the present disclosure may be implemented in accordance with one or more example embodiments. Referring to FIG. 6, computing system environment 600 may be used according to one or more illustrative embodiments. Computing system environment 600 is only one example of a suitable computing environment and is not intended to suggest any limitation as to the scope of use or functionality contained in the disclosure. Computing system environment 600 should not be interpreted as having any dependency or requirement relating to any one or combination of components shown in illustrative computing system environment 600.

Computing system environment 600 may include code generation and testing computing device 601 having processor 603 for controlling overall operation of code generation and testing computing device 601 and its associated components, including Random Access Memory (RAM) 605, Read-Only Memory (ROM) 607, communications module 609, and memory 615. Code generation and testing computing device 601 may include a variety of computer readable media. Computer readable media may be any available media that may be accessed by code generation and testing computing device 601, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by code generation and testing computing device 601.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor (e.g., hardware processor) on code generation and testing computing device 601. Such a processor may execute computer-executable instructions stored on a computer-readable medium.

Software may be stored within memory 615 and/or storage to provide instructions to processor 603 for enabling code generation and testing computing device 601 to perform various functions as discussed herein. For example, memory 615 may store software used by code generation and testing computing device 601, such as operating system 617, application programs 619, and associated database 621. Also, some or all of the computer executable instructions for code generation and testing computing device 601 may be embodied in hardware or firmware. Although not shown, RAM 605 may include one or more applications representing the application data stored in RAM 605 while code generation and testing computing device 601 is on and corresponding software applications (e.g., software tasks) are running on code generation and testing computing device 601.

Communications module 609 may include a microphone, keypad, touch screen, and/or stylus through which a user of code generation and testing computing device 601 may provide input, and may also include one or more of a speaker for providing audio output and a video display device for providing textual, audiovisual and/or graphical output. Computing system environment 600 may also include optical scanners (not shown).

Code generation and testing computing device 601 may operate in a networked environment supporting connections to one or more remote computing devices, such as computing devices 641 and 651. Computing devices 641 and 651 may be personal computing devices or servers that include any or all of the elements described above relative to code generation and testing computing device 601.

The network connections depicted in FIG. 6 may include Local Area Network (LAN) 625 and Wide Area Network (WAN) 629, as well as other networks. When used in a LAN networking environment, code generation and testing computing device 601 may be connected to LAN 625 through a network interface or adapter in communications module 609. When used in a WAN networking environment, code generation and testing computing device 601 may include a modem in communications module 609 or other means for establishing communications over WAN 629, such as network 631 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform, comprising:
at least one processor;
a communication interface communicatively coupled to the at least one processor; and
a memory storing computer-readable instructions that, when executed by the at least one processor, cause the computing platform to:
train a generative artificial intelligence (AI) model, wherein training the generative AI model causes the generative AI model to generate and test code for providing computer code provisioning;
receive technical specifications for generating a code segment;
execute the generative AI model, wherein executing the generative AI model includes inputting the technical specification to the generative AI model to output the code segment;
test, based on further execution of the generative AI model, the code segment to confirm compliance with one or more compliance criteria;
determine, based on the testing, whether the code segment complies with the one or more compliance criteria;
responsive to determining that the code segment does not comply with the one or more compliance criteria:
tune the generative AI model; and
execute the tuned generative AI model using the technical specifications as inputs; and
responsive to determining that the code segment does comply with the one or more compliance criteria, deploy the code segment.

2. The computing platform of claim 1, wherein the code segment is an infrastructure as code segment.

3. The computing platform of claim 1, wherein the one or more compliance criteria include enterprise domain specific criteria.

4. The computing platform of claim 1, wherein the one or more compliance criteria include regulatory criteria.

5. The computing platform of claim 1, wherein deploying the code segment further includes integrating the computing platform with one or more downstream systems.

6. The computing platform of claim 1, further including instructions that, when executed, cause the computing platform to:
responsive to determining that the code segment does not comply with the one or more compliance criteria:
generate a notification indicating non-compliance; and
transmit the notification to an enterprise user computing device, wherein transmitting the notification causes the notification to be displayed by a display of the enterprise user computing device.

7. The computing platform of claim 1, further including instructions that, when executed, cause the computing platform to:
responsive to determining that the code segment does comply with the one or more compliance criteria:
generate a notification indicating compliance and deployment of the code segment; and
transmit the notification to an enterprise user computing device, wherein transmitting the notification causes the notification to be displayed by a display of the enterprise user computing device.

8. The computing platform of claim 1, wherein training the generative AI model includes training the model using enterprise data related to business rules and external data related to regulatory requirements.

9. A method, comprising:
training, by a computing platform, the computing platform having at least one processor, and memory, a generative artificial intelligence (AI) model, wherein training the generative AI model causes the generative AI model to generate and test code for providing computer code provisioning;
receiving, by the at least one processor, technical specifications for generating a code segment;
executing, by the at least one processor, the generative AI model, wherein executing the generative AI model includes inputting the technical specification to the generative AI model to output the code segment;
testing, by the at least one processor and based on further execution of the generative AI model, the code segment to confirm compliance with one or more compliance criteria;
determining, by the at least one processor and based on the testing, whether the code segment complies with the one or more compliance criteria;
responsive to determining that the code segment does not comply with the one or more compliance criteria:
tuning, by the at least one processor, the generative AI model; and
executing, by the at least one processor, the tuned generative AI model using the technical specifications as inputs; and
responsive to determining that the code segment does comply with the one or more compliance criteria, deploying, by the at least one processor, the code segment.

10. The method of claim 9, wherein the code segment is an infrastructure as code segment.

11. The method of claim 9, wherein the one or more compliance criteria include enterprise domain specific criteria.

12. The method of claim 9, wherein the one or more compliance criteria include regulatory criteria.

13. The method of claim 9, wherein deploying the code segment further includes integrating the computing platform with one or more downstream systems.

14. The method of claim 9, further:
responsive to determining that the code segment does not comply with the one or more compliance criteria:
generating, by the at least one processor, a notification indicating non-compliance; and
transmitting, by the at least one processor, the notification to an enterprise user computing device, wherein transmitting the notification causes the notification to be displayed by a display of the enterprise user computing device.

15. The method of claim 9, further including:
responsive to determining that the code segment does comply with the one or more compliance criteria:
generating, by the at least one processor, a notification indicating compliance and deployment of the code segment; and
transmitting, by the at least one processor, the notification to an enterprise user computing device, wherein transmitting the notification causes the notification to be displayed by a display of the enterprise user computing device.

16. The method of claim 9, wherein training the generative AI model includes training the model using enterprise data related to business rules and external data related to regulatory requirements.

17. One or more non-transitory computer-readable media storing instructions that, when executed by a computing platform comprising at least one processor, memory, and a communication interface, cause the computing platform to:
train a generative artificial intelligence (AI) model, wherein training the generative AI model causes the generative AI model to generate and test code for providing computer code provisioning;
receive technical specifications for generating a code segment;
execute the generative AI model, wherein executing the generative AI model includes inputting the technical specification to the generative AI model to output the code segment;
test, based on further execution of the generative AI model, the code segment to confirm compliance with one or more compliance criteria;
determine, based on the testing, whether the code segment complies with the one or more compliance criteria;
responsive to determining that the code segment does not comply with the one or more compliance criteria:
tune the generative AI model; and
execute the tuned generative AI model using the technical specifications as inputs; and
responsive to determining that the code segment does comply with the one or more compliance criteria, deploy the code segment.

18. The one or more non-transitory computer-readable media of claim 17, wherein the one or more compliance criteria include enterprise domain specific criteria.

19. The one or more non-transitory computer-readable media of claim 17, further including instructions that, when executed, cause the computing platform to:
responsive to determining that the code segment does not comply with the one or more compliance criteria:
generate a notification indicating non-compliance; and
transmit the notification to an enterprise user computing device, wherein transmitting the notification causes the notification to be displayed by a display of the enterprise user computing device.

20. The one or more non-transitory computer-readable media of claim 17, further including instructions that, when executed, cause the computing platform to:
responsive to determining that the code segment does comply with the one or more compliance criteria:
generate a notification indicating compliance and deployment of the code segment; and
transmit the notification to an enterprise user computing device, wherein transmitting the notification causes the notification to be displayed by a display of the enterprise user computing device.
